(19) United States
(12) Patent Application Publication
(10) Pub. No.: US 2012/0312822 A1
(43) Pub. Date: Dec. 13, 2012

(54) Cookware with Thermal Indicator

(75) Inventors: Stanley Kin Sui Cheng, Hillsborough, CA (US); Tanveer Khan, Sriracha (TH)

(73) Assignee: MEYER INTELLECTUAL PROPERTIES LIMITED, Kowloon (HK)

(21) Appl. No.: 13/316,049

(22) Filed: Dec. 9, 2011

Related U.S. Application Data
(60) Provisional application No. 61/422,540, filed on Dec. 13, 2010.

(51) Int. Cl. A47J 27/00

(52) U.S. Cl. 220/573.1

(57) ABSTRACT

A cooking vessel or pan has a two part handle that comprises a flame guard flange portion attached to the pan wall via a stud and a grip portion attached to the flame guard portion via the stud. The flame guard portion is split into an upper and lower shell, with the upper shell urged to make good thermal contact with the pan wall by the grip portion and the lower portion disposed to generally insulate the upper shell and grip portion from direct heat from the heat source used in cooking. The upper shell preferably has at least a portion covered with a thermal indicating paint.

### CROSS REFERENCE TO RELATED APPLICATIONS

The present application claims the benefit of priority to the U.S. Provisional patent application for a “Cookware Handle with Heat Source Isolation for an Integrated Thermal Indicator” that was filed on Dec. 13, 2010, having application Ser. No. 61/422,540, which is incorporated herein by reference.

### BACKGROUND OF INVENTION

The present invention relates to a cookware article, and in particular to pots and pans with an attached handle that include a visual indicator of the vessel temperature.

Prior methods of indicating the temperature of a cookware article, such as a pot or pan deploy handles that connect to the sidewall of the pan via a flange portion which include a thermal sensor or indicator. As the handle or the flange portion is slowly heated by the pan the thermal indicator is triggered to visually indicate to the cook that the pan has reached a threshold temperature.

Prior art methods have used thermochromic inks or paints on the handle as thermal indicators. Others have tried to embed digital and analog type thermometers in the handle to provide an actual temperature display in degrees C. or F.

There is a need for a simple method of providing such thermal indicators, that are reasonably accurate, and in particular do not report a higher than actual pan temperature that would cause a cook to prematurely add food to the pan.

It is therefore a first object of the present invention to provide a simple visual indicator of pan temperature.

It is another objective of the invention to provide such an indicator of pan temperature that is easy to use.

It is still a further objective to provide such an indicator to a portion of a pan handle in a cost effective manner.

It is a further objective to provide a strong durable means for attaching a pan handle that is not in anyway compromised by providing the thermal indicator means.

### SUMMARY OF INVENTION

In the present invention, the first object is achieved by providing a cookware article having a thermal indicating handle, the cookware article comprising a cooking vessel having a generally circular bottom cooking surface and a surrounding sidewall that extend generally upward from the bottom cooking surface, wherein the bottom cooking surface has a center that define a radial coordinate system, at least one stud attached and extending outward in the generally radially direction from the surrounding sidewall of said cooking vessel, an upper shell disposed over at least the upward facing surface of said stud and having, at least an upper surface with a thermal indicating paint disposed on the upward facing side thereof and at least a proximal edge surface that conformingly contacts the surrounding sidewall of said cooking vessel in the vicinity of said stud, a lower shell disposed below at least downward facing surface of said stud and upper shell including the connecting portion thereof to shield said stud and upper shell form the direct heat of a heating source intended to transfer heat to the bottom cooking surface, an elongated handle with a grip portion at the distal end and a proximal end configured to urge at least the proximal edge surface of said upper shell against the surrounding sidewall of said cooking vessel when the proximal end thereof is connected to the stud.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1A is a plan view of an embodiment of the cooking vessel whereas FIG. 1B is cross-sectional elevation thereof. FIG. 1C is an enlarged detailed view of the portion of FIG. 1B in which the handle is attached to the pan, and FIG. 1D is an exterior elevation thereof.

FIG. 2A is an exploded perspective view of the cooking vessel and handle in FIG. 1A-D, and FIG. 2B is an enlarged detailed view of a portion thereof. FIG. 2C is a cross-sectional view through the portion of the handle and shown in FIG. 1D.

FIG. 3A-E illustrate the upper and lower shells that extended between the vessel and handle in the embodiments shown in FIGS. 1 and 2, in which FIG. 3A is a top plan view, FIG. 3B is a perspective view, FIG. 3C is a side elevation, FIG. 3D is a cross-sectional elevation and FIG. 3E is a detailed enlarged view of a portion of FIG. 3D.

FIG. 4A-E illustrate an alternative embodiment of the upper and lower shells that extended between the vessel and the handle in which FIG. 4A is a top plan view, FIG. 4B is a perspective view, FIG. 4C is a side elevation, FIG. 4D is a cross-sectional elevation and FIG. 4E is a detailed enlarged view of a portion of FIG. 3E.

FIG. 5A is a cross-sectional elevation of the handle and vessel deploying the upper and lower shell of FIG. 4A-E taken transverse to the handle axis whereas FIG. 5B is a cross-sectional thereof in the longitudinal or primary axis of the handle.

FIG. 6A is a cross-sectional elevation of another embodiment of handle and vessel deploying the upper and lower shell of FIG. 4A-E taken transverse to the handle axis whereas FIG. 6B is a cross-sectional thereof in the longitudinal or primary axis of the handle.

FIG. 7A is a cross-sectional elevation of another embodiment of handle and vessel deploying the upper and lower shell of FIG. 4A-E taken transverse to the handle axis whereas FIG. 7B is a cross-sectional thereof in the longitudinal or primary axis of the handle.

FIG. 8A is a cross-sectional elevation of another embodiment of handle and vessel deploying the upper and lower shell of FIG. 4A-E taken transverse to the handle axis whereas FIG. 8B is a cross-sectional thereof in the longitudinal or primary axis of the handle.

FIG. 9 is a cross-sectional elevation of another embodiment of a handle and vessel deploying at least one thermochromic indicating medium.

FIG. 10 is a cross-sectional elevation of another embodiment of a handle and vessel optionally deploying a thermochromic indicating medium.

### DETAILED DESCRIPTION

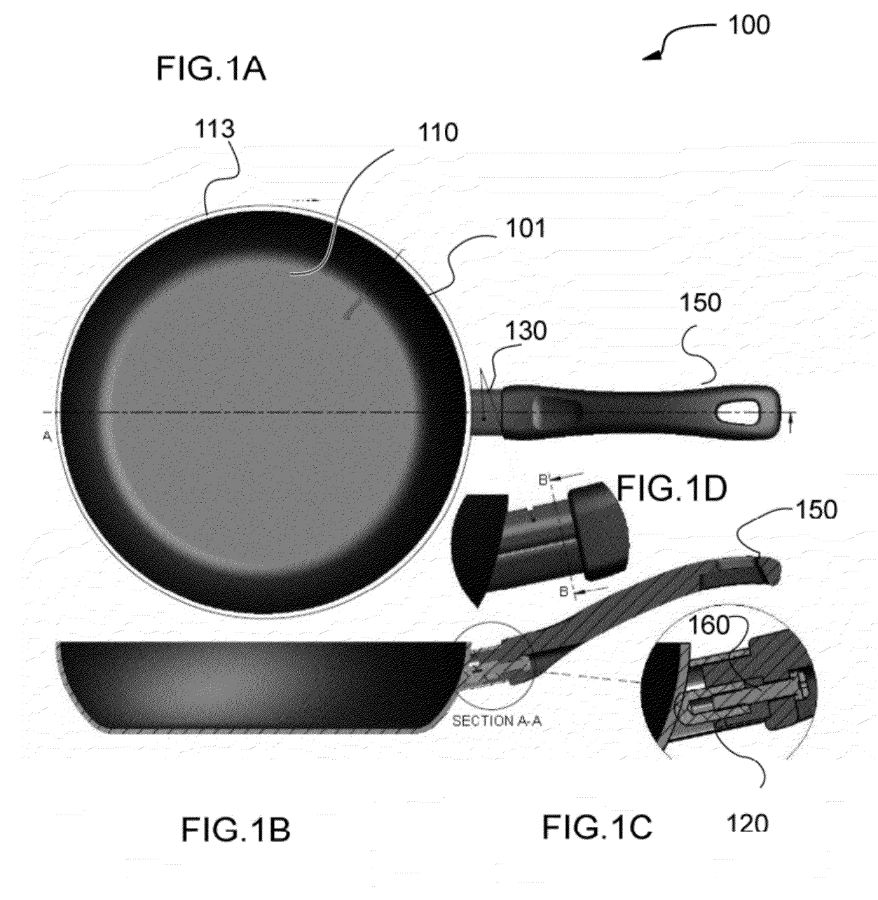

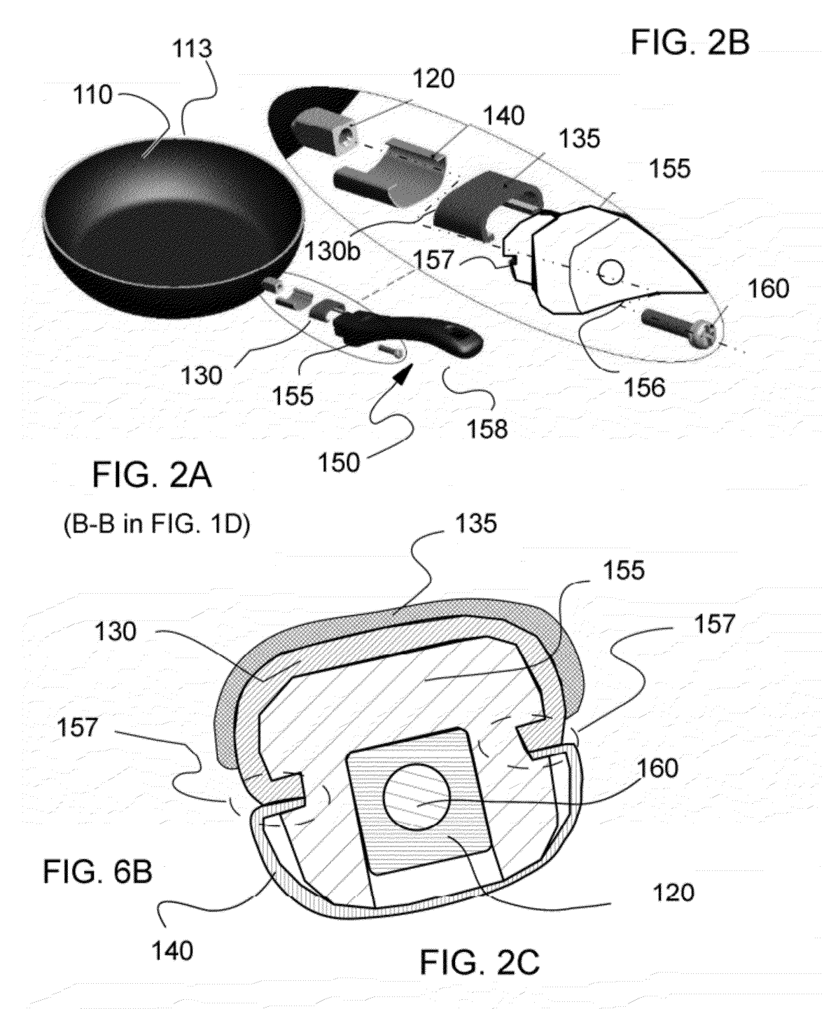

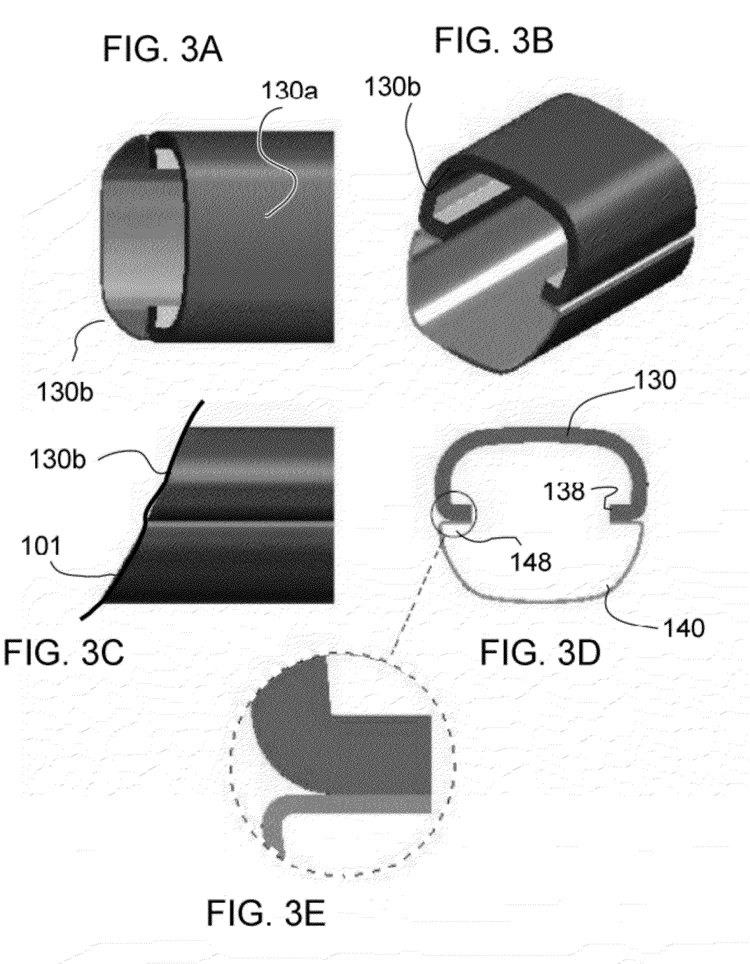

Referring to FIGS. 1 through 10, wherein like reference numerals refer to like components in the various views, there is illustrated therein a new and improved Cookware Handle with Heat Source Isolation for an Integrated Thermal Indicator, generally denominated 100 herein.

In accordance with the present invention the inventive cookware article 100 include a fluid retaining cookware vessel 110 having a stud 120 extending outward from the vessel wall 101. The stud 120 is placed bellow rim 113 of vessel 110. The stud 120 is used to attach a handle 150 to the vessel wall 101 in which an upper shell 130 covering the stud 120 has at least an upper surface 130a with a thermal indicating paint 135 and edge surfaces 130b that conform to the shape of the vessel wall in the region surrounding the stud. A lower shell 140 disposed below the upper shell 130 to serve as a flame shield that prevents heat escaping below the pan directly heating the handle 150 and the upper shell 130 having the thermal indicating paint 135. The elongated handle 150 has a grip portion 158 at the distal end and a connecting portion 155 at the proximal end that is configured to urge the portions of the upper shell against the cookware vessel wall when the proximal end is connected to the stud.

The upper shell is preferably good conductor of heat, being primarily of copper, aluminum or silver, to conduct heat from the pan wall 101. The lower shell 140 is preferably stainless steel, a much poorer conductor of heat, and makes limited contact with the upper shell 130, and thus prevents heat escaping the burner or heating source below the pan from overheating the upper shell 130 to provide a falsely high temperature reading.

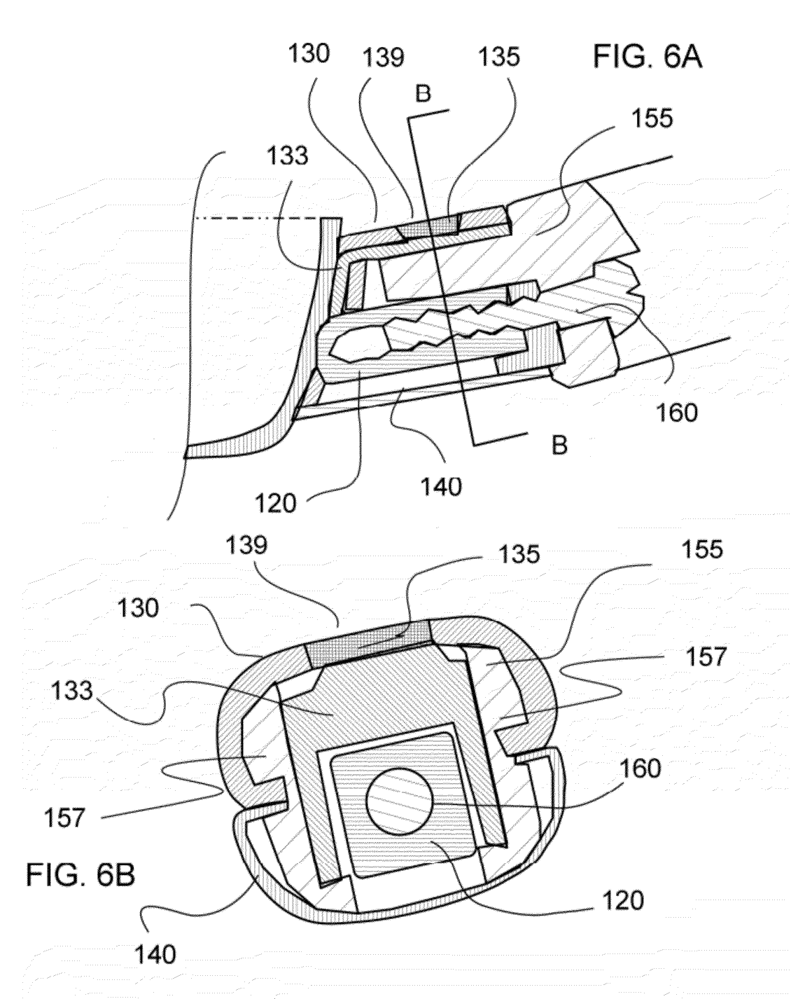

In another embodiment of the invention illustrated in FIG. 6, a thermal conducting means 133 provides thermal conductive between the vessel sidewall portion protected by the lower shell and the thermochromic indicator. Such thermal conducting means 133 is at least but preferably more thermally conductive than the vessel body materials, as for example a copper strip for a stainless steel or aluminum vessel. More preferably a highly thermally conducting means 133 is or contains a flexible graphite containing material as the thermal conducting element. One such source of a flexible graphite material is GRAFOIL® flexible graphite sheets are disclosed in U.S. Pat. Nos. 6,017,633 and 6,771,502 which are incorporated herein by reference.

The thermal conduction means or graphite foil 133 is optionally deployed below upper shell 130, which has an upper window or aperture 139 through which a thermochromic indicator layer is disposed or painted on the visible portion of the graphite foil. In this case it is actually beneficial that there is some insulation between the upper shell 130 and the graphite foil, or that the shell is a weak thermal conductor, such as plastic resin, an elastomer or a thermosetting polymer and the like. It may be more preferable that the graphite foil has an anisotropic thermal conductivity such that the heat conduction is greatest in the direction of the handle, provided heat is still readily conducted from the vessel wall into the sheet. The thermal resistance between the vessel wall and the thermal conduction means can be minimized with higher contact pressure exerted by handle 150, with an intervening thermal paste or adhesive, or by welding the thermal conduction means to the vessel wall.

The thermochromic paint should undergo a distinct visual change in color when it reaches a temperature of about 100 to 225° C., and may rely on an inorganic or organic pigment to provide such change in color. If the thermal contact resistance between the pan wall 101 and the upper shell 130 is small, and the vessel is small or has very good thermal conductivity, as for example with a copper pan, then the thermochromic paint 135 can have a transition temperature close to the ideal cooking temperature, about 175 to 225° C., which of course depends on what is being cooked and the cooking method. However, when the heat transfer is poor, and the upper shell will be someone lower in temperature when the center of the pan reaches the ideal cooking temperature, then a lower transition temperature thermochromic indicator can be deployed to account for this thermal lag.

Numerous thermochromic materials that undergo sharp, reversible visual metachromism in response to temperature changes are known in the art. Such materials are optionally based on both inorganic materials and organic materials including various forms of encapsulated liquid crystals. For example, U.S. Pat. No. 4,028,118 issued to Nakasuji et al., which is incorporated herein by reference, discloses such a material. Typically, these materials contain, as indispensable components, an electron-donating, chromatic organic compound, a compound having a phenolic hydroxyl group, and a compound selected from the group consisting of higher aliphatic monatomic alcohols and higher aliphatic monatomic acid alcohol esters. The '118 patent further discloses that the thermochromic characteristics of such a thermochromic material can be further improved when it is occluded in fine microcapsules having a size not exceeding 50 microns and that thermochromic polymers, thermochromic printing inks, thermochromic writing instruments, thermochromic paints and thermochromic sheets having excellent thermochromatic characteristics and wide utility can be prepared from such a thermochromic material or microencapsulated thermochromic material.

Inorganic thermochromic paint compositions suitable for use at higher temperatures, are disclosed in U.S. Pat. No. 5,499,597 to Kronberg (issued Mar. 19, 1996), which is incorporated herein by reference. More specifically, the '597 patent discloses reversible optical temperature indicators that utilize inorganic semiconductors which vary in color in response to various temperature levels. The semiconductor material is enclosed in enamel, which provides protection and prevents breakdown at higher temperatures. U.S. Pat. No. 6,551,693, discloses iron oxide alone used as a chemical substance which changes color as a function of temperature is applied over the thermostable resin which resists temperatures up to at least 2000 C. and which coats the surface of the cooking vessel. The thermostable resin is described as being preferably a fluorocarbon resin or a mixture of exclusively fluorocarbon resins or of fluorocarbon resins mixed with other thermostable resins. As an alternative to using iron oxide alone, iron oxide can be mixed with other pigments or coloring agents, such as perylene red bonded to a black pigment. Such pure and pigmented iron oxides have a similar color at room temperature, but increase in contrast when heated. A current commercial source for thermochromic inks and paints is Chromatic Technologies, Inc., 4870 Centennial Blvd. Ste. 126, Colorado Springs, Colo. 80919.

Preferably, the stud 120 has a threaded bore 125 at the distal end for receiving a screw 160 that passes through a bore in the handle to urge the handle 150 against at least one of the stud 120, upper shell 130 and lower shell 140.

Further, a connecting portion 155 of the elongated handle 150 has a bore 156 with an inner profile that matches the stud's outer dimension so it can to slide over the stud 120.

Preferably, the connecting portion 155 of the handle 150 has slots 157 formed in opposing sides. The slots 157 extend in the generally radial direction with respect to the center of the pan or vessel 101, or along the longitudinal or primary axis of the elongated handle 150. The upper shell and lower shell have inward facing edges 138 and 148 respectively that are inserted into the slot 157 in the connecting portion 155 of the handle 150. The coupling of the upper and lower shell firmly with handle 150 via the slots 157 provides for the from end or face portion 130a, or a similar part of the lower shell 140 to be urged firmly against the vessel wall 101, and thus better distributes the load of the full pan or vessel 101 to the handle 150 reducing the stress on the stud 120.

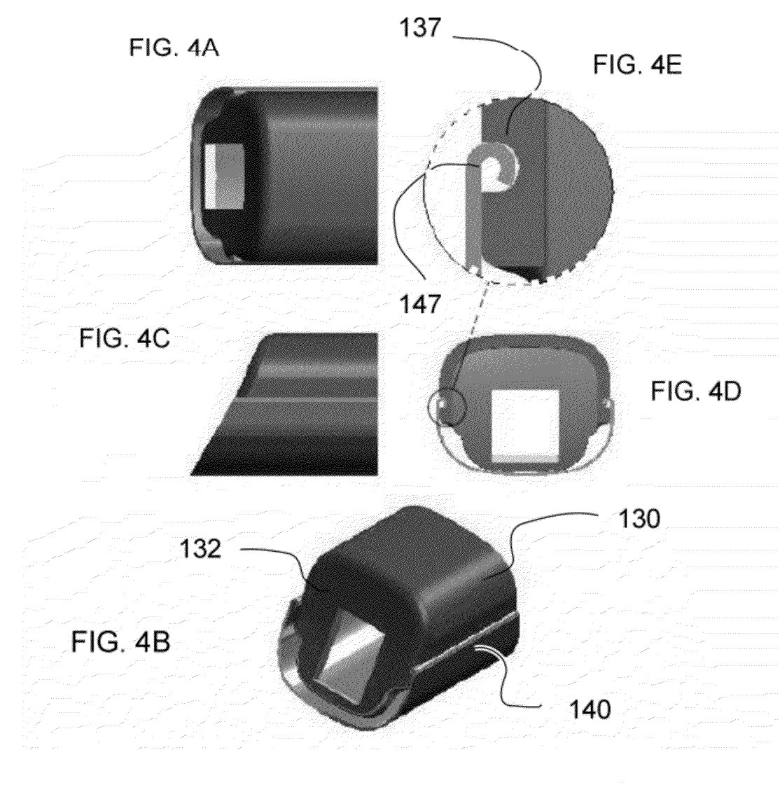

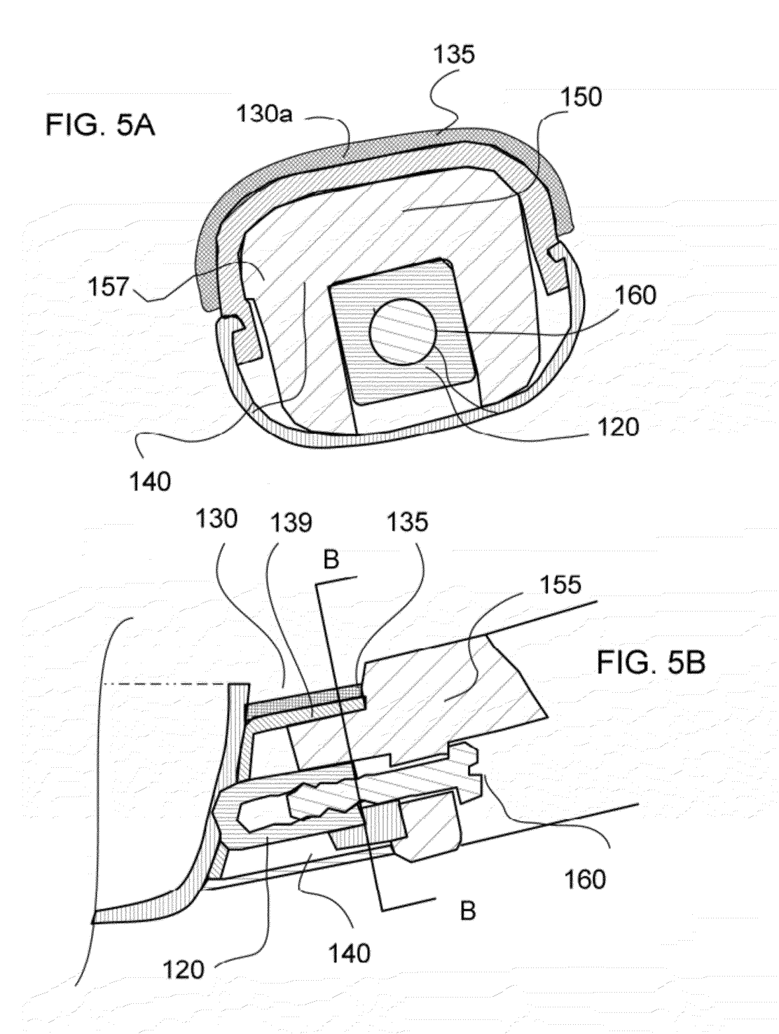

In the alternative embodiment of FIGS. 4 and 5, the upper shell 130 is optionally configured with at least one conforming connecting portion 132 disposed generally perpendicular to the plane of the upper shell that covers the stud 120. The conforming connecting portion can be a relatively poor thermal conductor if it urges the thermally conducting means 133 against the sidewall 101 of the vessel. This conforming connecting portion 132 has a slot or whole that fits over the stud 120. The lower shell 140 can be suspended from the upper shell 130 by rails 147 that engage slots 137 that are formed in the general radial extending direction from each side of the upper shell 130. The stud 120 cross section is preferably non-circular, in this case rectangular, to prevent rotation of the upper and lower shells, and the slot 132 is intended to conforming fit thereon to preclude its rotation.

The preferably the conforming connecting portion can be an extension of the upper shell 130 that conforms to the shape of the vessel wall in the region surrounding the stud to provide good thermal contact and excellent thermal conduct to the thermochromic material.

The proximal end or connection portion 155 of the handle 150 urges at least the upper shell 130 against the vessel sidewall either directly at the distal edge or indirectly via the conforming connecting portion 132, if present. The proximal end or connection portion 155 of the handle 150 has a complimentary mating profile to seat within at least one of the distal end of the upper 130 and/or lower 140 shells and the conforming connecting section 132. To the extent that the upper and lower shells have minimal contact or connect via a less thermally conductive handle connection portion 155, heat transfer from the lower shell to the upper shell is minimized.

The proximal end of the grip portion of the handle urges the upper shell against the vessel wall either directly at the distal edge or indirectly via the connecting portion 155. The conforming connecting portion 132 of the upper shell 130 is at the distal end of the upper shell. The stud 120 is welded to the outside of the pan or is a connected via rivet that extends through the vessel side wall, with the rivet head disposed inside the vessel;

At least one of the inner and outer shell preferably lockingly engage the proximal or connecting portion 155 of the handle 150 when inserted therein. Alternatively, the engagement of the upper shell and the proximal portion of the handle can be via a ratchet means that includes vertical teeth or channels having the opposite tilt so that they cannot be pulled backward, but only advanced forward once engaged.

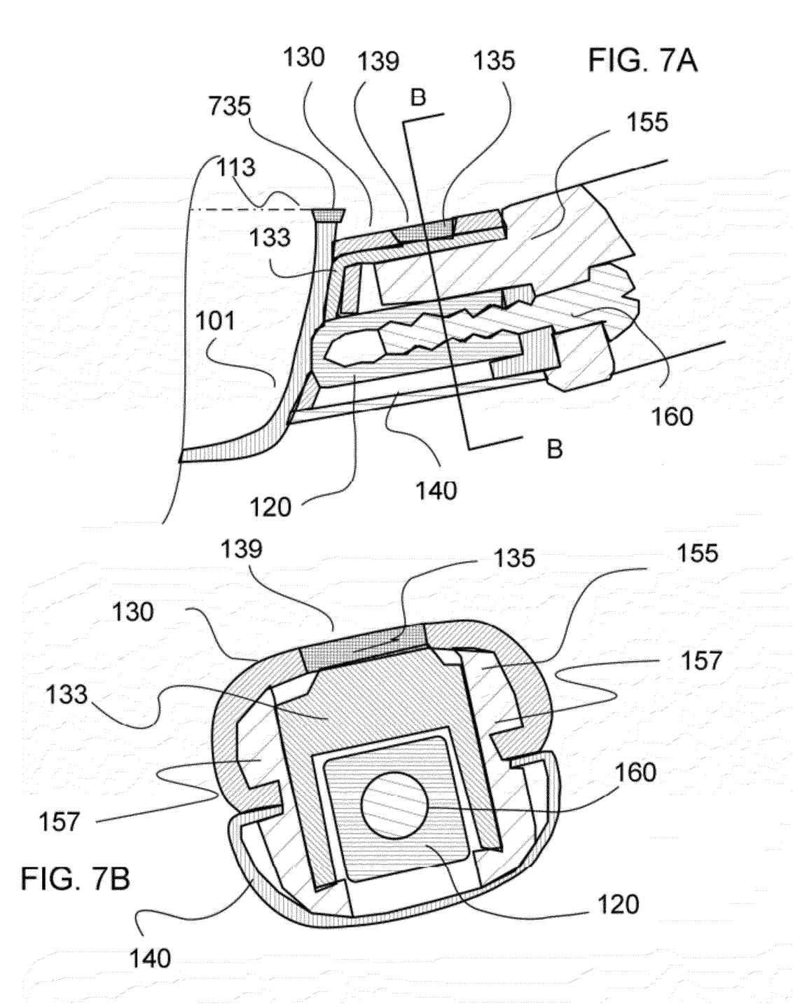

In an alternative embodiment of the invention, a thermochromic colored portion or coating 735 can be provided on the upward facing rim 113 of the cookware article, as shown in FIG. 7-10, as an alternative or addition a colored portion on the upward facing surface of the handle

Thus, as shown in FIGS. 7A and 7B there is a one thermochromic pigmented region 735 on rim 113 and another visible on the adjacent portion of the handle but in thermal communication with the vessel sidewall via the thermal conduction means 133.

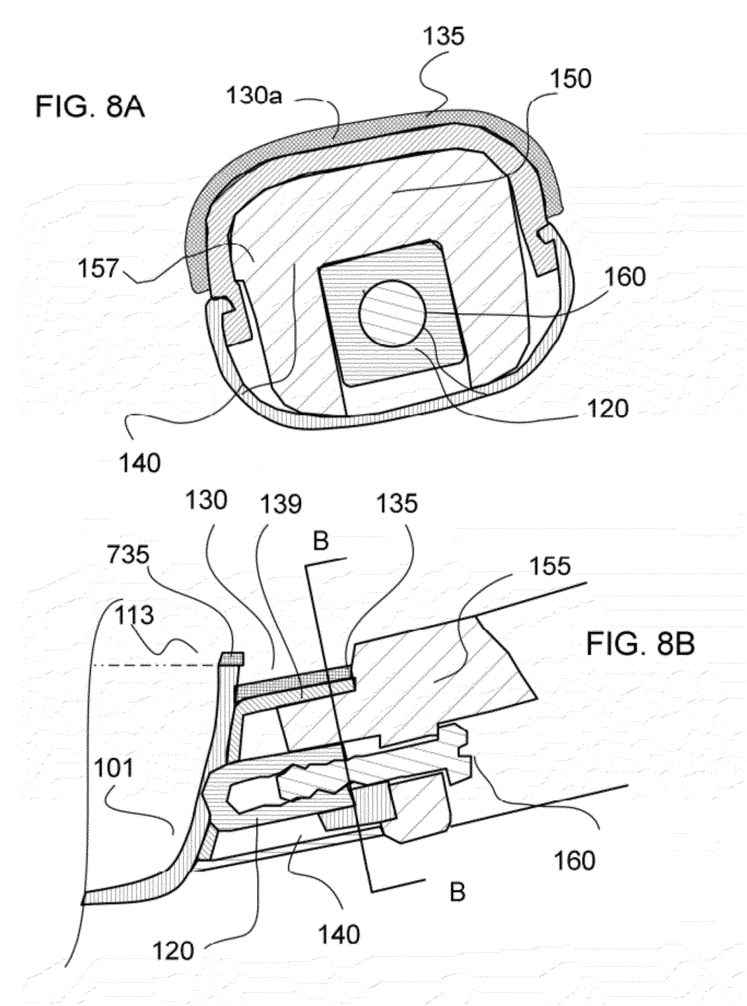

In addition, as shown in FIGS. 8A and 8B there is a one thermochromic pigmented region 735 on rim 113 and the adjacent visible portion of the handle has a thermally stable colorant 135, such a containing a color stable pigment on a portion of the flange that is not heated, which is adjacent to the rim 113 color changing portion.

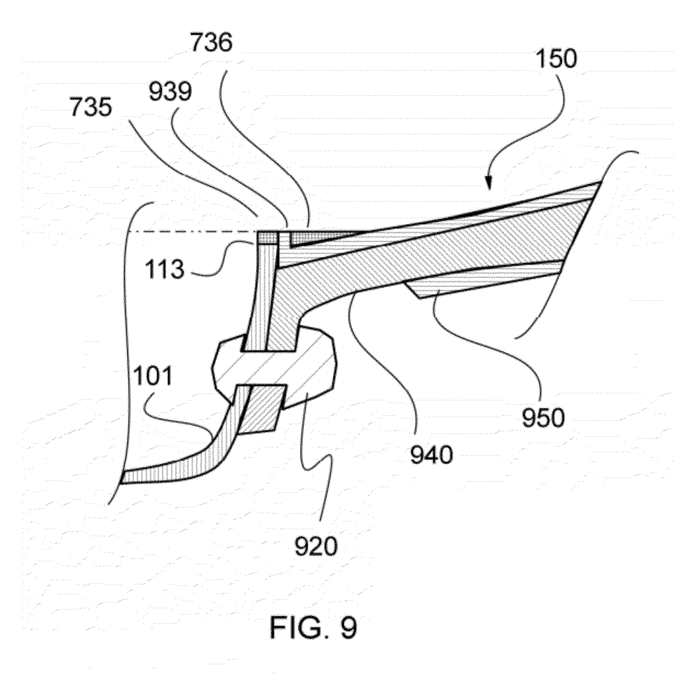

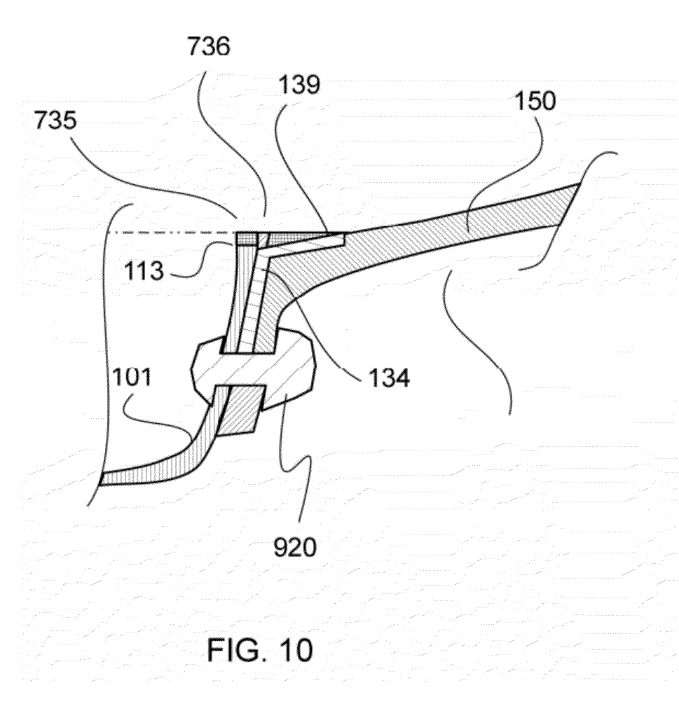

FIGS. 9 and 10 illustrate further embodiments of the invention in which the vessel is attached directly to the handle 150 with rivets 920, via a flange portion 940 of the handle 150. Depending on the thermal conductivity of the handle flange 940, a thermal isolating medium 939, such as a high temperature resistant rubber, plastic or resin may be deployed between the flange 140 and the coloring region 736 on handle 150 if the intention is not to heat the colored region thereon. Such a medium 939 can also be a rubber or plastic grip 950 that covers a substantial portion of the handle 150 that is distal to the flange 940.

If two thermochromic pigmented or colored regions are deployed on adjacent heatable surfaces (i.e. the rim 113 and a portion of the handle or flange that is also heated by the pan, and not burner) it is preferably that they color changes in a manner that makes the color change on the rim 113 or flange/handle portion more noticeable, as for example, when having similar color when cold, but different color on heating. Thus, it is particularly preferable if the thermochromic coloring 735 on rim 113 change contrasts as it heats with respect to the thermochromic coloring region 135 in thermal communication with the thermal conduction means 133 or otherwise heated by vessel sidewall 101. For example, as shown in FIG. 10, regions 737 and 735 may have a similar or identical colors at room temperature, but can change shade in opposite directs to increase in contrast as they warm up and eventually come to the coating temperature, as for example one lightens and the other darkens, or one changes in chroma value or an alternative color space coordinate in a different direction than the other.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

I claim:

1) A cookware article having a thermal indicating handle, the cookware article comprising:
a) a cooking vessel having a generally circular bottom cooking surface and a surrounding sidewall that extends generally upward from the bottom cooking surface to terminate at a rim, wherein the bottom cooking surface has a center that define a radial coordinate system,
b) at least one stud attached and extending outward in the generally radially direction from the surrounding sidewall of said cooking vessel,
c) an upper shell disposed over at least the upward facing surface of said stud and having;
i) at least an upper surface with a first thermochromic indicator disposed on the upward facing side thereof and at least a proximal edge surface that conformingly contacts the surrounding sidewall of said cooking vessel in the vicinity of said stud,
d) a lower shell disposed below at least a downward facing surface of said stud and upper shell including the connecting portion thereof to shield said stud and upper shell form the direct heat of a heating source when used to transfer heat to the bottom cooking surface,
e) an elongated handle with a grip portion at the distal end and a proximal end configured to urge at least the proximal edge surface of said upper shell against the surrounding sidewall of said cooking vessel when the proximal end thereof is connected to the stud.

2) The cookware article having a thermal indicating handle according to claim 1 wherein the upper shell further comprises at least one conforming connecting portion having at least one of an aperture and a recessed cavity formed therein, the connecting portion descending generally downward from the upper surface of the said upper shell and coupled to a portion thereof wherein the shape of the conforming connecting portion conforms to the shape of the shape of the sidewall of the vessel

3) The cookware article having a thermal indicating handle according to claim 1 wherein the upper and lower shells are coupling to each other via complimentary rail and slot engaging means.

4) The cookware article having a thermal indicating handle according to claim 1 further comprising a thermal conducting medium in thermal communication with the thermochromic indicator that is urged against surrounding sidewall of said cooking vessel but is thermally isolated from the lower shell.

5) The cookware article having a thermal indicating handle according to claim 4 wherein the thermal conducting medium is graphite foil.

6) The cookware article having a thermal indicating handle according to claim 1 wherein the rim of said vessel is covered by a second thermochromic indicator.

7) The cookware article having a thermal indicating handle according to claim 6 wherein the contrast between the first and second thermochromic indicators increases upon there upward increase in temperature from room temperature.

8) A thermal indicating cookware article, the cookware article comprising:
a) a cooking vessel having a bottom cooking surface and a surrounding sidewall that extends generally upward from the bottom cooking surface to terminate at a rim,
b) an elongated handle with a grip portion at the distal end and a proximal end coupled to the sidewall of the cookware vessel, the proximal end having on an upward facing surface adjacent to the rim a first colored region formed from a first coloring medium, with a second colored region formed from a second coloring medium disposed on at least an upward facing portion of handle proximal to the rim of the cookware vessel, wherein the contrast between the first and second coloring medium increases when the temperature increase thereof.

9) The thermal indicating cookware article according to claim 8 that further comprises a thermal conduction means between the sidewall of the cookware vessel and the second coloring region on the handle.

10) The thermal indicating cookware article according to claim 8 that further comprises a means to urge the heat conduction means against the sidewall of the cookware vessel.

11) The thermal indicating cookware article according to claim 8 wherein the thermal conduction means is graphite foil.

12) The thermal indicating cookware article according to claim 8 and further comprising means to thermally isolate the portion of the handle in thermal communication with the first colored region.

13) A cookware article having a thermal indicating handle according to claim 8 wherein the first and second coloring regions are both thermochromic indicators.

14) A thermal indicating cookware article, the cookware article comprising:
a) a cooking vessel having a bottom cooking surface and a surrounding sidewall that extends generally upward from the bottom cooking surface to terminate at a rim,
b) an elongated handle with a grip portion at the distal end and a proximal end coupled to the sidewall of the cookware vessel, the proximal end having on a upward facing surface adjacent to the rim with a first colored region formed from a first coloring medium that is thermochromic and further comprising means to urge the portion of the handle in thermal communication with the first colored region to make thermal contact with the sidewall of the vessel.

15) The thermal indicating cookware article according to claim 14 wherein the handle comprises a second coloring means to provide indicating contrast as the first colored region changes color on increasing in temperature.

16) The thermal indicating cookware article according to claim 14 that further comprises means to thermally isolate the portion of the handle in thermal communication with the first colored region.

17) The thermal indicating cookware article according to claim 14 that further comprises a thermal conduction means between the sidewall of the cookware vessel and the second coloring region on the handle.

18) The thermal indicating cookware article according to claim 17 wherein the thermal conduction means is graphite foil.

19) The thermal indicating cookware article according to claim 16 that further comprises a thermal conduction means between the sidewall of the cookware vessel and the second coloring region on the handle.

20) The thermal indicating cookware article according to claim 19 wherein the thermal conduction means is graphite foil.
